(19) United States
(12) Patent Application Publication
(10) Pub. No.: US 2026/0110281 A1
(43) Pub. Date: Apr. 23, 2026

(54) MODULAR DUST BOX AND ELECTRONIC LEAK CHECK MODULE (ELCM) HOUSING ASSEMBLY

(71) Applicant: MAHLE International GmbH, Stuttgart (DE)

(72) Inventors: Eric Mathes, Shelby Twp., MI (US); Antonio Spadafora, Tecumseh (CA)

(21) Appl. No.: 19/363,123

(22) Filed: Oct. 20, 2025

Related U.S. Application Data
(60) Provisional application No. 63/709,294, filed on Oct. 18, 2024.

(51) Int. Cl. F02M 25/08

(52) U.S. Cl. CPC F02M 25/0872

(57) ABSTRACT

A modular dust box and electronic leak check module (ELCM) housing assembly may include a housing and a plurality of attachment formations connected to the housing. The housing may be one of a filter housing and an ELCM housing. The housing may be connectable to at least one of a support structure, a mounting bracket, and another housing via the plurality of attachment formations.

### CROSS-REFERENCE TO RELATED APPLICATIONS

This application claims priority to U.S. Provisional Ser. No. 63/709,294, filed on Oct. 18, 2024, the contents of each of which is hereby incorporated by reference in its entirety.

### TECHNICAL FIELD

The present disclosure generally relates to modular dust box and evaporative leak check module (ELCM) housing assemblies that may, for example, be used in connection with electronic emission control systems and/or vehicles (e.g., automotive vehicles).

### BACKGROUND

An Evaporative Emission Control (EVAP) System may be coupled to an internal combustion engine to prevent fuel vapors (e.g., gasoline vapors) from escaping from a fuel tank and fuel system into the atmosphere. A common EVAP system includes a carbon canister, which may also be referred to as a fuel vapor canister or fuel canister, a filter, and an electronic leak check module (ELCM). The filter and the ELCM are typically arranged within their own separate housings. The housing enclosing the filter, which may be referred to as a first housing, a filter housing, and/or a dust box, and the housing enclosing the ELCM, which may be referred to as a second housing and/or an ELCM housing, are usually mounted on a vehicle structure in close proximity to one another and connected to one another by a conduit. Due to the design variations between different vehicles, however, many vehicles are equipped with an EVAP system in which the dust box and/or the ELCM housing has a unique design, arrangement, and mounting structure specific to that vehicle. Each vehicle design having its own unique design and/or variant of the dust box and the ELCM housing leads to high development costs and high tooling costs.

Accordingly, there is a need for an improved EVAP system and/or an improved dust box and evaporative leak check module (ELCM) housing assembly that minimizes or eliminates one or more challenges or shortcomings of existing designs.

### SUMMARY

According to a first aspect, a modular dust box and electronic leak check module (ELCM) housing assembly, may include a first housing, a second housing, a mounting bracket configured to secure the assembly to a support structure, and a plurality of attachment formations. The plurality of attachment formations may include a plurality of first fasteners and a plurality of second fasteners configured in a complimentary manner to the plurality of first fasteners. At least one set of first fasteners may be disposed on the first housing. At least one set of second fasteners may be disposed on the second housing. A set of first fasteners and/or a set of second fasteners may be disposed on the mounting bracket. The first housing, the second housing, and the mounting bracket may be connectable to one another in a plurality of different arrangements via engaging at least some of the plurality of first fasteners and at least some of the plurality of second fasteners with one another.

Pursuant to an implementation, the mounting bracket may include a base plate configured to be connected to the support structure. The set of first fasteners and/or the set of second fasteners may be disposed on and project from the base plate. The set of first fasteners and the set of second fasteners may be arranged offset from one another on the base plate.

Pursuant to an implementation, the at least one set of first fasteners of the first housing may include a plurality of sets of first fasteners. Additionally and/or alternatively, the at least one set of second fasteners of the second housing may include a plurality of sets of second fasteners.

Pursuant to an implementation, the mounting bracket may include the set of first fasteners and the set of second fasteners. In a first arrangement, i) a first set of first fasteners of the first housing may be engaged with one of the plurality of sets of second fasteners of the second housing and/or ii) a second set of first fasteners of the first housing may be engaged with the set of second fasteners of the mounting bracket. In a second arrangement, i) a first set of second fasteners of the second housing may be engaged with one of the plurality of sets of first fasteners of the first housing and/or ii) a second set of second fasteners of the second housing may be engaged with the set of first fasteners of the mounting bracket.

Pursuant to an implementation, the at least one set of first fasteners of the first housing may include a plurality of sets of first fasteners. A first set of first fasteners of the plurality of first fasteners may be disposed on and project from a first side of the first housing. A second set of first fasteners of the plurality of first fasteners may be disposed on and project from a second side of the first housing. The second side of the first housing may be i) disposed opposite the first side of the first housing or ii) disposed adjacent to the first side of the first housing and oriented transversely to the first side.

Pursuant to an implementation, the at least one set of first fasteners of the first housing may include a plurality of sets of first fasteners. A first set of first fasteners of the plurality of first fasteners may be disposed on and project from a first side of the first housing. A second set of first fasteners of the plurality of first fasteners may be disposed on and project from a second side of the first housing. A third set of first fasteners of the plurality of first fasteners may be disposed on and project from a third side of the first housing. The second side of the first housing may be disposed opposite the first side of the first housing. The third side may be disposed adjacent to the first side and oriented transversely to the first side.

Pursuant to an implementation, each of the plurality of first fasteners may be structured as a male fastener or a female fastener. Additionally and/or alternatively, each of the plurality of second fasteners may be structured as the other of the male fastener and the female fastener.

Pursuant to an implementation, the first housing may be one of a filter housing and an ELCM housing. The second housing may be the other one of the filter housing and the ELCM housing. Optionally, the assembly may further include a filter arranged in the filter housing and/or an ELCM arranged in the ELCM housing.

According to a second aspect, a modular dust box and electronic leak check module (ELCM) housing assembly may include a housing and a plurality of attachment formations connected to the housing. The housing may be one of a filter housing and an ELCM housing. The housing may be connectable to at least one of a support structure, a mounting bracket, and another housing via the plurality of attachment formations.

Pursuant to an implementation, the plurality of attachment formations may include a plurality of weld flanges. The plurality of weld flanges may each include a first member projecting from the housing and a second member disposed at a free end of the first member.

Pursuant to an implementation, the assembly may further include the another housing. The another housing may be the other one of the filter housing and the ELCM housing.

Pursuant to an implementation, the plurality of attachment formations may include a plurality of first fasteners and a plurality of second fasteners configured in a complimentary manner to the plurality of first fasteners. At least one set of first fasteners may be disposed on and project from the housing. At least one set of second fasteners may be disposed on and project from the another housing.

Pursuant to an implementation, the at least one set of first fasteners of the housing may include a plurality of sets of first fasteners. Additionally and/or alternatively, the at least one set of second fasteners of the another housing may include a plurality of sets of second fasteners.

Pursuant to an implementation, a first set of first fasteners of the plurality of first fasteners may be disposed on and project from a first side of the housing. A second set of first fasteners of the plurality of first fasteners may be disposed on and project from a second side of the housing.

Pursuant to an implementation, the second side of the housing may be i) disposed opposite the first side of the housing or ii) disposed adjacent to the first side of the housing and oriented transversely to the first side.

Pursuant to an implementation, each of the plurality of first fasteners may be structured as a male fastener or a female fastener. Additionally and/or alternatively, each of the plurality of second fasteners may be structured as the other of the male fastener and the female fastener.

Various other features and advantages will be made apparent from the following detailed description and the drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective, exploded view of a portion of a first exemplary modular dust box and electronic leak check module (ELCM) housing assembly according to teachings of the present disclosure;

FIGS. 2A and 2B are a side view and a front view, respectively, of the assembly of FIG. 1 in a first arrangement;

FIG. 3 is a front view of the assembly of FIG. 1 in a second arrangement;

FIG. 4 is a front view of a portion of a second exemplary modular dust box and electronic leak check module (ELCM) housing assembly according to teachings of the present disclosure;

FIG. 5 is a perspective, exploded view of a portion of a third exemplary modular dust box and electronic leak check module (ELCM) housing assembly according to teachings of the present disclosure;

FIGS. 6A and 6B are a side view and a front view, respectively, of the assembly of FIG. 5 in a first arrangement;

FIG. 7 is a front view of the assembly of FIG. 5 in a second arrangement;

FIG. 8 is a front view of the assembly of FIG. 5 in a third arrangement;

FIG. 9 is a front view of the assembly of FIG. 5 in a fourth arrangement;

FIG. 10 is a perspective view of the assembly of FIG. 5 in a fifth arrangement mounted to a vehicle;

FIG. 11 is a perspective view of the assembly of FIG. 5 in the first arrangement mounted to a vehicle;

FIG. 12 is a perspective view of a portion of a fourth exemplary modular dust box and electronic leak check module (ELCM) housing assembly mounted to a vehicle;

FIG. 13 is a perspective view of an exemplary bleed housing according to teachings of the present disclosure;

FIG. 14 is a perspective view of a fifth exemplary modular dust box and electronic leak check module (ELCM) housing assembly including the bleed housing of FIG. 13; and

FIG. 15 is a perspective view of the assembly of FIG. 14 mounted to a vehicle.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Disclosed is a modular dust box and electronic leak check module (ELCM) housing assembly 100, 200, 300, 400, 500, which may simply be referred to as the assembly 100, 200, 300, 400, 500 herein. The assembly 100, 200, 300, 400, 500 may, for example, be part of and/or used in connection with an evaporative emission control system (EVAP system) and/or a vehicle (e.g., an automotive vehicle). The assembly 100, 200, 300, 400, 500 includes a first housing 110 (e.g., a dust box and/or a filter housing), a filter 124, and a plurality of attachment formations 160. Optionally, the assembly 100, 200, 300, 400, 500 further includes a second housing 130 (e.g., an ELCM housing), an ELCM 144, one or more mounting brackets 190, one or more conduits 198, and/or a bleed housing 146. The mounting bracket(s) 190 is configured to be connected to and/or mounted on a portion of a vehicle, such as a support structure 10, and secures the assembly 100, 200, 300, 400, 500 to the support structure 10 and/or the vehicle. The first housing 110, the second housing 130, the attachment formations 160, and/or the mounting bracket 190 are composed of plastic and/or metal, but other materials are also conceivable.

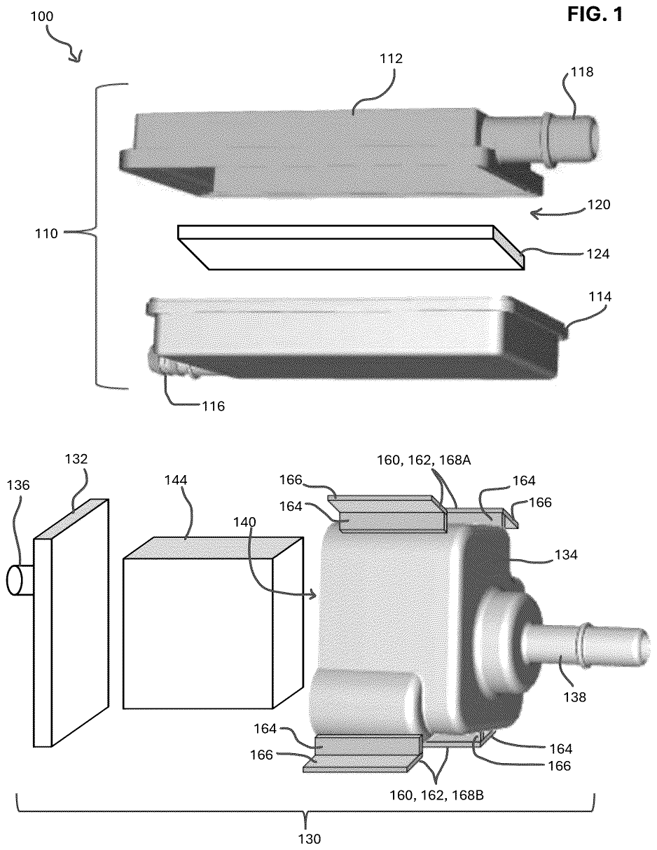

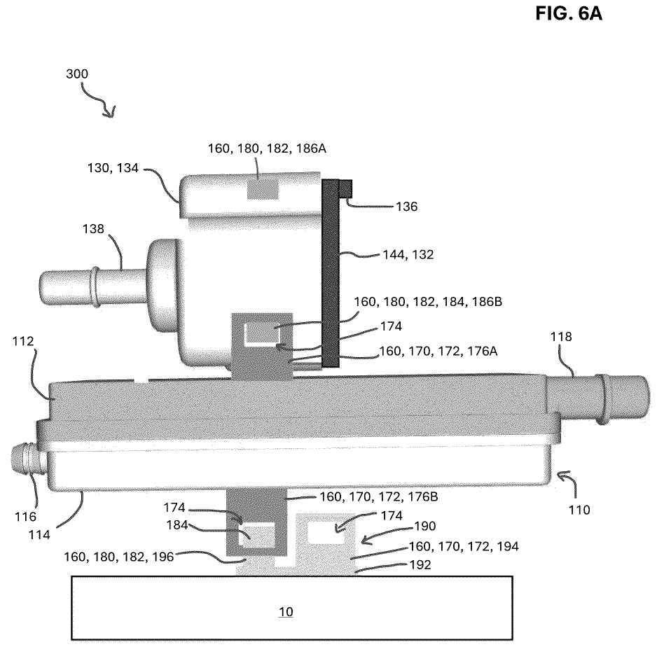

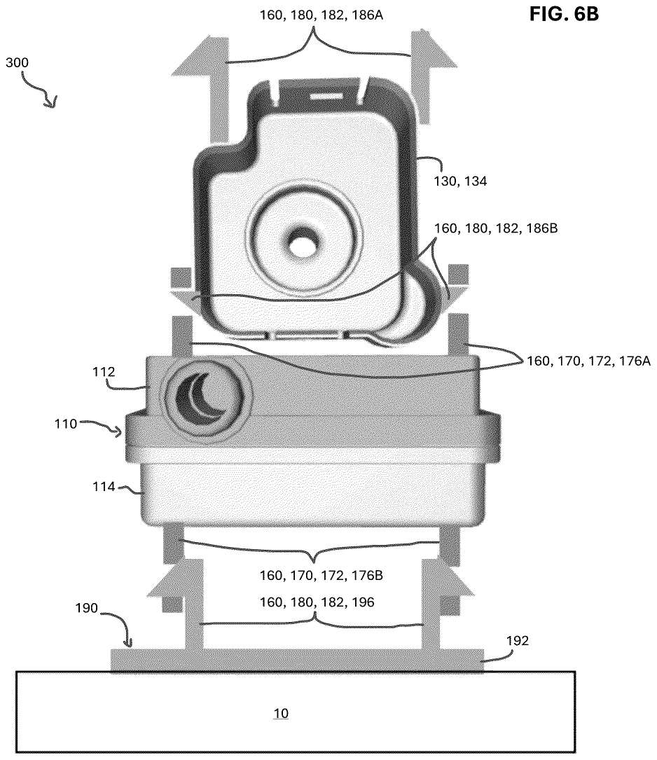

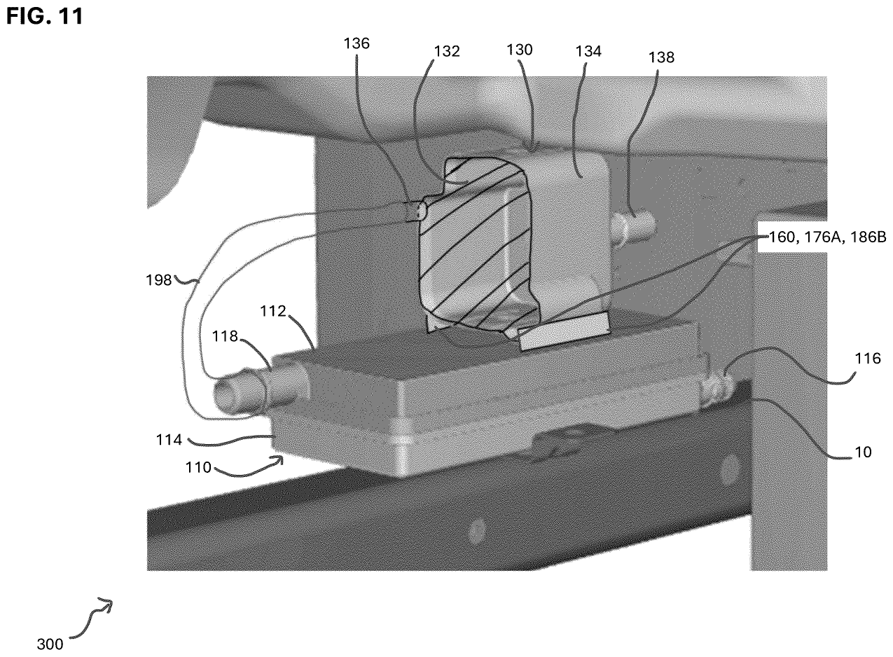

The first housing 110 encloses and protects the filter 124. The first housing 110 includes a first housing shell 112, a second housing shell 114, an inlet 116, and an outlet 118. In some examples, such as those depicted in FIGS. 6-12, the first housing 110 also includes one or more portions of the attachment formations 160 (e.g., a plurality of first fasteners 170). In other examples, such as the one depicted in FIGS. 1-4, the first housing 110 does not include a portion of the attachment formations 160. The first housing shell 112 and the second housing shell 114 are connected to one another (e.g., permanently, such as via a weld) to form and/or define the first housing 110. The first and second housing shells 112, 114 define an internal space 120 of the first housing 110 in which the filter 124 is arranged. The first housing shell 112 includes the outlet 118 and the second housing shell 114 includes the inlet 116. Alternatively, the first housing shell 112 includes the inlet 116 and the second housing shell 114 includes the outlet 118, the first housing shell 112 includes both the inlet 116 and the outlet 118, or the second housing shell 114 includes both the inlet 116 and the outlet 118. A fluid, such as air from the surrounding environment, is flowable into the first housing 110 via the inlet 116. The fluid is flowable out from the first housing 110 via the outlet 118. A conduit 198 connects the outlet 118 of the first housing 110 to the inlet 136 of the second housing 130 such that the first housing 110 and the second housing 130 are in fluid communication with one another (see, e.g., FIG. 11). During operation, fluid (e.g., environmental air) flows through the inlet 116 into the first housing 110, passes through the filter 124 which removes particles, contaminants and/or debris from the fluid, flows out of the first housing 110 and into the conduit 198 via the outlet 118, and flows through the conduit 198 and into the second housing 130 via the inlet 136 of the second housing 130.

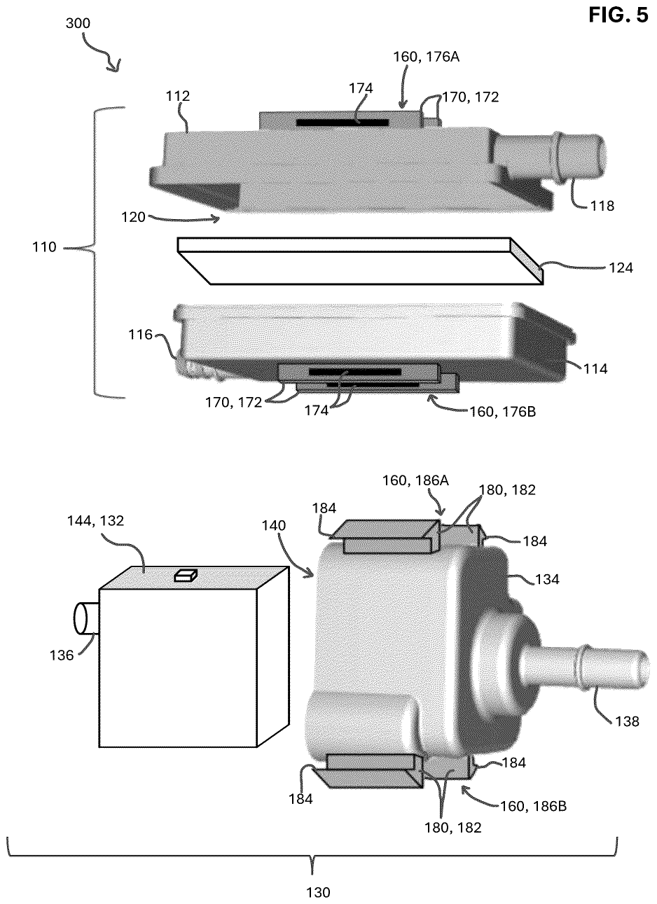

The second housing 130 encloses and protects the ELCM 144. The second housing 130 includes a first housing shell 132, a second housing shell 134, an inlet 136, and an outlet 138. The second housing 130 further includes one or more portions of the attachment formations 160 (e.g., a plurality of weld flanges 162 and/or a plurality of second fasteners 180). The first housing shell 132 and the second housing shell 134 are connected to one another to form and/or define the second housing 130. The second housing 130 and/or the second housing shell 134 includes an internal space 140 in which the ELCM 144 is (e.g., at least partially and/or completely) arranged. Optionally, the first housing shell 132 may be configured as and/or form part of the ELCM 144 (see, e.g., FIG. 5). The first housing shell 132 includes the inlet 136 and the second housing shell 134 includes the outlet 138. Alternatively, the first housing shell 132 includes the outlet 138 and the second housing shell 134 includes the inlet 136, the first housing shell 132 includes both the inlet 136 and the outlet 138, or the second housing shell 134 includes both the inlet 136 and the outlet 138. The cleaned and/or filtered fluid that is discharged and/or output by the first housing 110 flows into the second housing 130 via the inlet 136. The fluid is flowable out from the second housing 130 via the outlet 138. The outlet 138 of the second housing 130 is connected to the carbon canister of the EVAP system, such as by a conduit. The outlet 138 of the second housing 130 is connectable and/or connected to an inlet of the carbon canister such that the second housing 130 and the carbon canister are in fluid communication with one another. During operation, the cleaned and/or filtered fluid (e.g., air) discharged and/or output by the first housing 110 (e.g., via the outlet 118) flows through the conduit 198 and into the second housing 130 via the inlet 136, passes through and/or interacts with one or more components of the ELCM 144 (e.g., a sensor), flows out of the second housing 130 through the outlet 138, and flows into the carbon canister (e.g., via flowing through a conduit). The sensor of the ELCM 144 may detect one or more properties, qualities, and/or characteristics of the fluid discharged and/or output by the first housing 110 (e.g., the cleaned and/or filtered external air).

The first housing 110, second housing 130, mounting bracket 190, and/or support structure 10 are connectable to one another in a plurality of different arrangements via the attachment formations 160 (e.g., via welding different combinations of weld flanges 162 to the first housing 110, the mounting bracket 190, and/or the support structure; via engaging different combinations of first fasteners 170 and second fasteners 180). As such, the position and orientation of the first housing 110 and of the second housing 130 relative to one another and relative to the support structure 10 can be modified, adjusted, and/or customized to achieve a desired position, orientation, and mounting of the assembly 100, 200, 300, 400, 500, such as to suit the environment in which the assembly 100, 200, 300, 400, 500 is being mounted. As a result, the assembly 100, 200, 300, 400, 500 can be utilized for several different vehicles thereby reducing development and tooling costs.

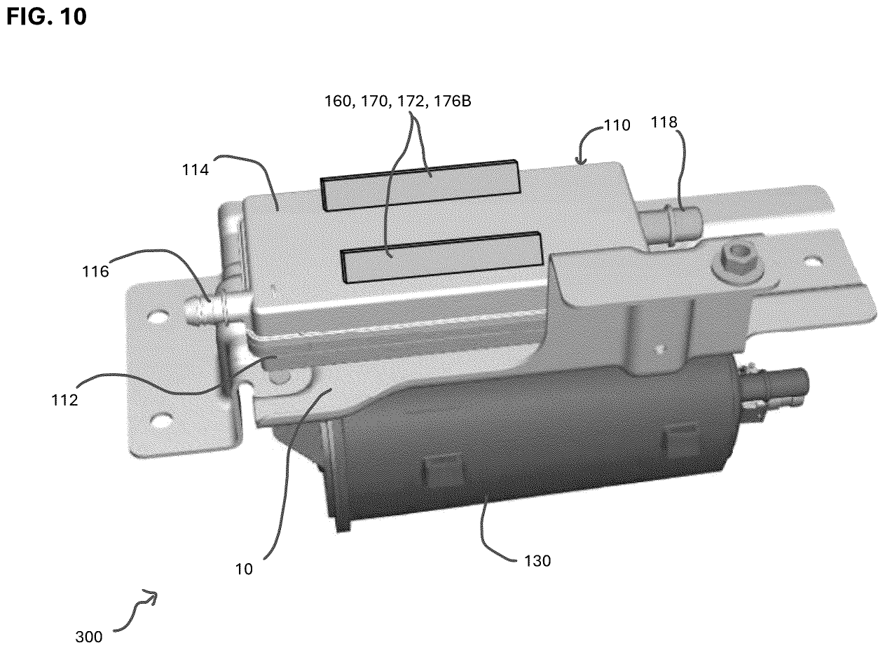

For example, in some implementations and/or arrangements, such as those depicted in FIGS. 1-9, 11, and 12, the first housing 110 and the second housing 130 are connected to one another via the attachment formations 160. One of the first housing 110 and the second housing 130 is then connected directly to the support structure 10 (see, e.g., FIGS. 1-4) or is connected indirectly to the support structure 10 via one or more mounting brackets 190 (see, e.g., FIGS. 5-9, 11, and 12), which secures the other housing 110, 130 connected thereto to the support structure 10. In other implementations and/or arrangements, such as the arrangement depicted in FIG. 10, the first housing 110 and the second housing 130 are not directly connected to one another via the attachment formations 160 and are each individually connected to the support structure 10 (e.g., directly or via a respective mounting bracket 190 of a plurality of mounting brackets 190).

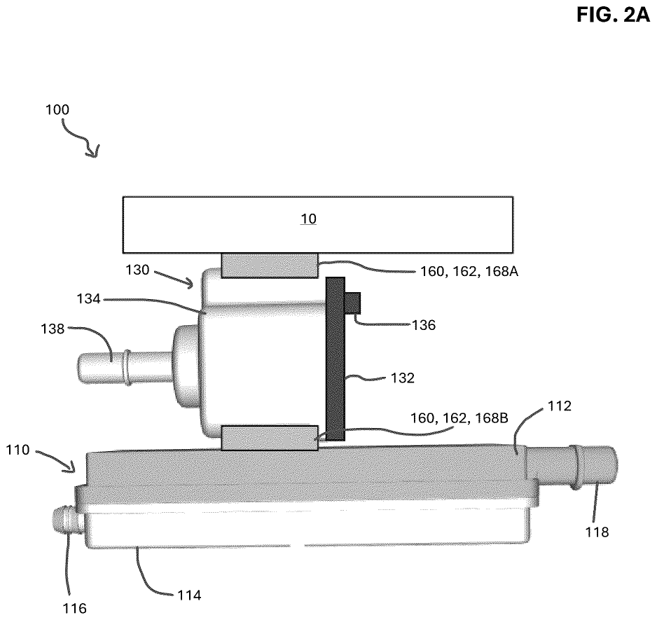

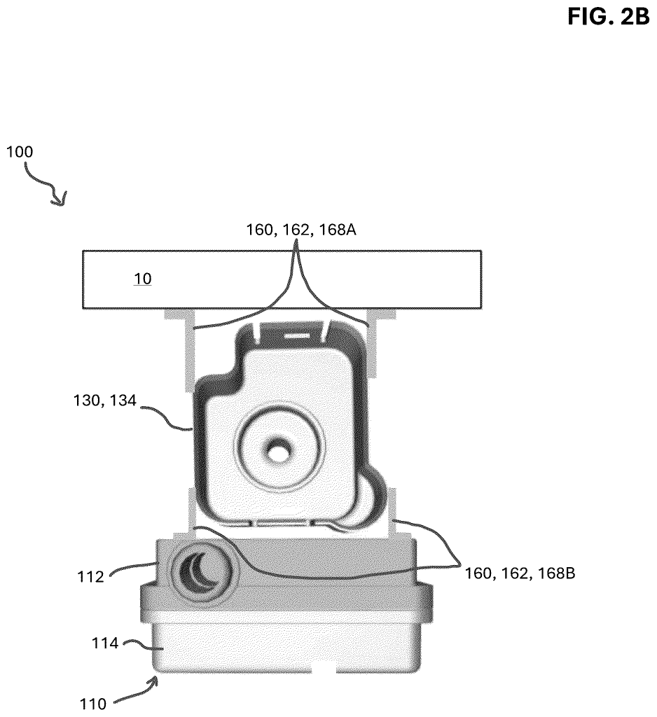

Note that the ELCM 144 and the first housing shell 132 of the second housing 130 are not illustrated in FIGS. 2B-4, 6B-9, and 12. Additionally, in the front view of the assembly 200 depicted in FIGS. 6B-9, the attachment formations 160 are shown in cross-section to more clearly illustrate the engagement of the first fasteners 170 and the second fasteners 180.

An illustrative assembly 100 that may be connected directly to and/or mounted directly on the support structure 10 is depicted in FIGS. 1-3. The assembly 100 may alternatively be connected to the support structure 10 indirectly, such as via one or mounting brackets 190, however. In the illustrative assembly 100, the attachment formations 160 are structured as and/or include a plurality of flanges 162, which may be configured to be welded to the first housing 110, the support structure 10, and/or the mounting bracket 190. The flanges 162 are connected to and project from the second housing 130 (e.g., the second housing shell 134 of the second housing 130). As generally illustrated in FIG. 1, the flanges 162 are each generally L-shaped and include a first member 164 connected to the second housing 130 and a second member 166 projecting transversely (e.g., perpendicularly) from a free end of the first member 164. The second member 166 is structured in a complimentary manner to a surface of the first housing 110, mounting bracket 190, and/or support structure 10 to facilitate welding of the second member 166 thereto. However, other suitable shapes and/or configurations of the flanges 162 are conceivable.

The second housing 130 includes a plurality of pairs, groups, and/or sets of flanges 162 of the attachment formations 160, at least some of which are disposed on different sides of the second housing 130. A first pair, group, and/or set of flanges 168A is disposed on a first side of the second housing 130 and a second pair, group, and/or set of flanges 168B is disposed on a different, second side of the second housing 130. The second side of the second housing 130 is disposed opposite the first side and has a similar orientation as the first side. The second side may alternatively be disposed adjacent to the first side and/or oriented transversely to the first side (e.g., the first side may be a top or bottom side and the second side may be a lateral side, or visa versa). While the second housing 130 is illustrated with two sets of flanges 168A, 168B herein, the second housing 130 may have more than two or less than two sets of flanges 162 (e.g., one set of flanges 162; three sets of flanges 162 with a first set on a first side, a second set on a second side opposite the first side, and a third set on a third side disposed adjacent to and/or oriented transversely to the first and/or second sides; six sets of flanges 162; etc.).

During assembly and/or installation of the assembly 100, one set of the flanges 168A, 168B is connected (e.g., welded) directly to the support structure 10 thereby securing and/or connecting the second housing 130 and the support structure 10 to one another. Alternatively, this set of flanges 168A, 168B may be connected (e.g., welded) to a mounting bracket 190 that is itself connected (e.g., welded) to the support structure 10 as previously mentioned. The other set of the flanges 168A, 168B is connected (e.g., welded) directly to the first housing 110 securing and/or connecting the first housing 110 and the second housing 130 to one another. The second housing 130 thus connects and/or secures the assembly 100 and/or the first housing 110 to the support structure 10.

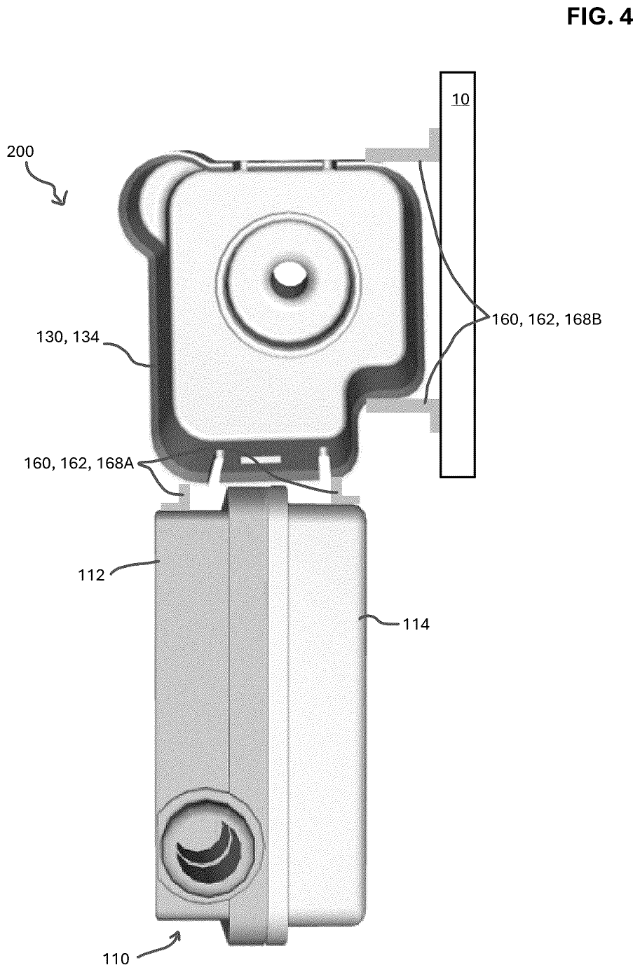

In a first arrangement of the assembly 100 depicted in FIGS. 2A and 2B, the first set of flanges 168A are connected (e.g., welded) to the support structure 10, the second set of flanges 168B are connected (e.g., welded) to the first housing 110, and, optionally, the first housing 110 is suspended from the support structure 10 via the second housing 130. The first set of flanges 168A are connected to an underside and/or an underside surface of the support structure 10, but may alternatively be connected to a topside and/or topside surface of the support structure 10 or to a lateral side and/or a lateral side surface of the support structure 10. The second set of flanges 168B are connected (e.g., welded) to the first housing shell 112 of the first housing 110. Alternatively, the orientation of the first housing 110 relative to the second housing 130 can be altered as desired and the second set of flanges 168B connected to the second housing shell 114 of the first housing 110 (e.g., a 180 degree rotation of the first housing 110 in FIG. 2B) or to both housing shells 112, 114 of the first housing 110 (e.g., a 90 degree rotation of the first housing 110 in FIG. 2B, which may look similar to the orientation of the first housing 110 in FIG. 4). In other alternatives, the orientation of the second housing 130 relative to the first housing 110 can be reversed such that the second set of flanges 168B are connected (e.g., welded) to the support structure 10 and the first set of flanges 168A are connected (e.g., welded) to the first housing 110 (e.g., the first housing shell 112, the second housing shell 114, or both housing shells 112, 114 depending on the desired orientation of the first housing 110).

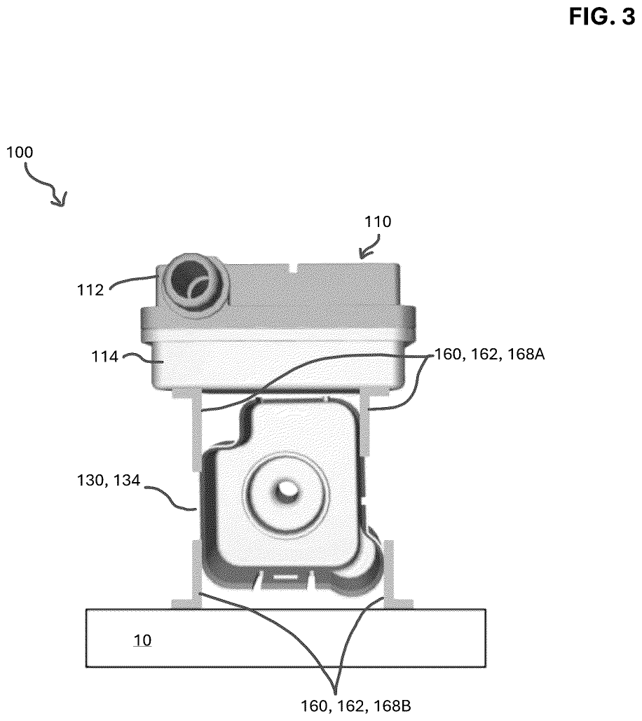

In a second arrangement of the assembly 100 depicted in FIG. 3, the first set of flanges 168A are connected (e.g., welded) to the first housing 110, the second set of flanges 168B are connected (e.g., welded) to the support structure 10, and the second housing 130 acts as a support, stand, and/or mount for the first housing 110. The second set of flanges 168B are connected to a topside and/or a topside surface of the support structure 10, but may alternatively be connected to an underside and/or an underside surface of the support structure 10 or to a lateral side and/or a lateral side surface of the support structure 10. The first set of flanges 168A are connected (e.g., welded) to the second housing shell 114 of the first housing 110. Alternatively, the orientation of the first housing 110 relative to the second housing 130 can be altered as desired and the first set of flanges 168A connected to the first housing shell 112 of the first housing 110 (e.g., a 180 degree rotation of the first housing 110 in FIG. 3) or to both housing shells 1124, 114 of the first housing 110 (e.g., a 90 degree rotation of the first housing 110 in FIG. 3, which may look similar to the orientation of the first housing 110 in FIG. 4). In other alternatives, the orientation of the second housing 130 relative to the first housing 110 can be reversed such that the second set of flanges 168B are connected (e.g., welded) to the support structure 10 and the first set of flanges 168A are connected (e.g., welded) to the first housing 110 (e.g., the first housing shell 112, the second housing shell 114, or both housing shells 112, 114 depending on the desired orientation of the first housing 110).

While not illustrated herein, in a third arrangement of the assembly 100, the first housing shell 112 of the first housing 110 is connected to the support structure 10 (e.g., via one or more mechanical fasteners, adhesive, and/or weld) and one set of the flanges 168A, 168B of the second housing 130 (e.g., the first set of flanges 168A or the second set of flanges 168B depending on the desired orientation of the second housing 130) is connected (e.g., welded) to the second housing shell 114 of the first housing 110. In a fourth arrangement (unillustrated) of the assembly 100, the second housing shell 114 of the first housing 110 is connected to the support structure 10 (e.g., via one or more mechanical fasteners, adhesive, and/or weld) and one set of the flanges 168A, 168B of the second housing 130 (e.g., the first set of flanges 168A or the second set of flanges 168B depending on the desired orientation of the second housing 130) is connected (e.g., welded) to the first housing shell 112 of the first housing 110. In some situations, such as when the third arrangement and/or the fourth arrangement are desired, the unused set of flanges 168A, 168B may optionally be removed from the second housing 130 (e.g., prior to and/or after installation of the assembly 100) and/or the second housing 130 may be produced and/or provided without the unused flanges 168A, 168B to reduce the amount of space occupied by the assembly 100 and/or to provide cost savings (e.g., reduce production costs).

The illustrative assembly 200 depicted in FIG. 4 is a variation of the assembly 100 depicted in FIGS. 1-3 in which the two sets of flanges 168A, 168B are disposed on adjacent and/or transversely extending sides of the second housing 130. The first set of flanges 168A are arranged on a first and/or bottom side of the second housing 130 and are connected to the first and second housing shells 112, 114 of the first housing 110. The second set of flanges 168B are arranged on a second and/or lateral side of the second housing 130 and are connected to a lateral side and/or surface of the support structure 10. The second housing 130 is, therefore, laterally offset from the support structure 10 and the first housing 110 is suspended from and/or below the second housing 130. The position, orientation, and connections between the first housing 110, the second housing 130, and the support structure 10 can be modified, adjusted, and/or customized to achieve a variety of different arrangements of the assembly 200, which are not described in detail for brevity.

Another illustrative assembly 300 is depicted in FIGS. 5-11. The assembly 300 includes one or more mounting brackets 190 that connect the assembly 300 to and/or mount the assembly 300 on the support structure 10. In the illustrative assembly 300, the attachment formations 160 are structured as and/or include a plurality of first fasteners 170 and a plurality of second fasteners 180 that are complimentary to and releasably engageable with the first fasteners 170. The plurality of first fasteners 170 are disposed on and project from the first housing 110 and/or the mounting bracket 190. The plurality of second fasteners 180 are disposed on and project from the second housing 130 and/or the mounting bracket 190. The first and second fasteners 170, 180 may be male/female fasteners, latches, clips, and/or other type of suitable mechanical connectors that are used to connect components to one another. In the illustrative example herein, the first fasteners 170 are female fasteners structured as a tab 172 and/or projection including an aperture 174 and the second fasteners 180 are male fasteners structured as a latch 182 including a latch nose 184 that is engageable with and/or receivable in the aperture 174 of a respective tab 172. Alternatively, the first fasteners 170 may be structured as the male fasteners (e.g., latches 182) and the second fasteners 180 may be structured as the female fasteners (e.g., the tabs 172).

The first housing 110 includes a plurality of pairs, groups, and/or sets of first fasteners 170 of the attachment formations 160, at least some of which are disposed on different sides of the first housing 110. A first pair, group, or set of first fasteners 176A are disposed on and project from a first side of the first housing 110 and a second pair, group, or set of first fasteners 176B are disposed on and project from a different, second side of the first housing 110. The second side of the first housing 110 is disposed opposite the first side and has a similar orientation as the first side. However, the second side may alternatively be disposed adjacent to the first side and/or oriented transversely to the first side (e.g., the first side may be a top or bottom side and the second side may be a lateral side, or visa versa). The first set of first fasteners 176A are disposed on and project from the first housing shell 112 of the first housing 110 and the second set of first fasteners 176B are disposed on and project from the second housing shell 114 of the first housing 110. Alternatively, one or more of the sets of first fasteners 174A, 174B may be disposed on and project from both the first and second housing shells 112, 114. For example, a set of first fasteners 174A may include two first fasteners 170 that are arranged on a lateral side of the first housing 110 with one of the first fasters 170 disposed on the first housing shell 112 and the other first fastener 170 disposed on the second housing shell 114. While the first housing 110 is illustrated with two sets of first fasteners 176A, 176B herein, the first housing 110 may have more than two or less than two sets of first fasteners 170 (e.g., one set of first fasteners 170, three sets of first fasteners 170 with a first set on a first side, a second set on a second side opposite the first side, and a third set on a third side disposed adjacent to and/or oriented transversely to the first and/or second sides; six sets of first fasteners 170; etc.).

The second housing 130 includes a plurality of pairs, groups, and/or sets of second fasteners 180 of the attachment formations 160, at least some of which are disposed on different sides of the second housing 130. A first pair, group, or set of second fasteners 186A are disposed on a first side of the second housing 130 and a second pair, group, or set of second fasteners 186B are disposed on a different, second side of the second housing 130. The second side of the second housing 130 is disposed opposite the first side and has a similar orientation as the first side. However, the second side may alternatively be disposed adjacent to the first side and/or oriented transversely to the first side (e.g., the first side may be a top or bottom side and the second side may be a lateral side, or visa versa). In the illustrative example herein, the first set and the second set of second fasteners 186A, 186B are disposed on and project from the second housing shell 134 of the second housing 130. Alternatively, one or more of the sets of second fasteners 186A, 186B may be disposed on and project from the first housing shell 132 and/or both the first and second housing shells 132, 134. For example, a set of second fasteners 186A may include two second fasteners 180 with one disposed on the first housing shell 132 and the other disposed on the second housing shell 134. While the second housing 130 is illustrated with two sets of second fasteners 186A, 186B herein, the second housing 130 may have more than two or less than two sets of second fasteners 180 (e.g., one set of second fasteners 180, three sets of second fasteners 180 with a first set on a first side, a second set on a second side opposite the first side, and a third set on a third side disposed adjacent to and/or oriented transversely to the first and/or second sides; six sets of second fasteners 180, etc.).

At least some of the attachment formations 160 (e.g., one or more first fasteners 170 and/or second fasteners 180) are also disposed on and project from a base body and/or base plate 192 of the mounting bracket 190, which is configured to be secured and/or connected (e.g., welded) to the support structure 10. As shown in FIG. 6A, the mounting bracket 190 includes at least one pair, group, and/or set of first fasteners 194 of the attachment formations 160 and at least one pair, group, and/or set of second fasteners 196 of the attachment formations 160. The set of first fasteners 194 and the set of second fasteners 196 are arranged on the base plate 192 offset from one another. Having both the first and second fasteners 170, 180 of the attachment formations 160 enables the mounting bracket 190 to be connected to the first housing 110 and/or to the second housing 130 and, thus, a greater number of arrangements of the assembly 300 are possible. Alternatively, the mounting bracket 190 may only include one or more sets of first fasteners 194 or only include one or more sets of second fasteners 196.

The first housing 110, the second housing 130, and the mounting bracket 190 can be arranged, oriented, and connected to one another and to the support structure 10 in a variety of different arrangements, such as those depicted in FIGS. 6A-10, due to the configuration of the attachment formations 160 (e.g., via engaging at least some of the plurality of first fasteners 170 and at least some of the plurality of second fasteners 180 with one another). As such, the position, orientation, and mounting of the assembly 300 and/or the elements thereof can be modified, adjusted, and/or customized as needed and/or desired, such as to suit the environment in which the assembly 300 is being mounted. The assembly 300 can therefore be utilized for several different vehicles, which reduces development and tooling costs.

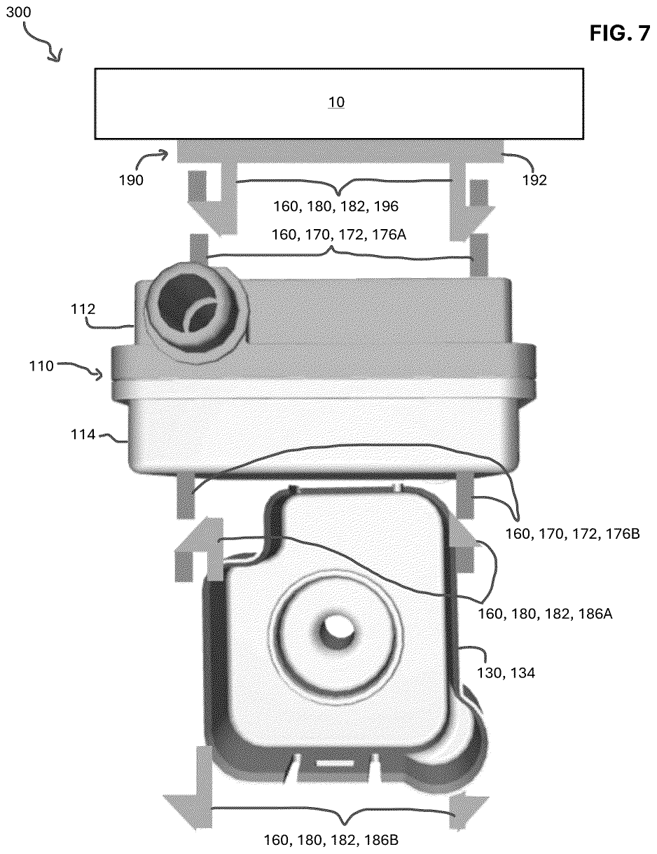

In some arrangements of the assembly 300 (e.g., FIGS. 6A-7, and 11), one set of first fasteners 176A, 176B of the first housing 110 are engaged with one of the sets of second fasteners 186A, 186B of the second housing 130 and another set of first fasteners 176A, 176B of the first housing 110 are engaged with the set of second fasteners 196 of the mounting bracket 190 such that the first housing 110 is disposed between and connects the second housing 130 and the mounting bracket 190 to one another. For example, in a first arrangement of the assembly 300 shown in FIGS. 6A, 6B, and 11, the first set of first fasteners 176A of the first housing 110 are engaged with the second set of second fasteners 186B of the second housing 130 and the second set of first fasteners 176B of the first housing 110 are engaged with the set of second fasteners 196 of the mounting bracket 190. In the second arrangement of the assembly 300 shown in FIG. 7, the first set of first fasteners 176A of the first housing 110 are engaged with the set of second fasteners 196 of the mounting bracket 190 and the second set of first fasteners 176B of the first housing 110 are engaged with the first set of second fasteners 186A of the second housing 130. The sets of first fasteners 176A, 176B of the first housing 110 may alternatively be connected to the other set of second fasteners 186A, 186B of the second housing 130 in the first arrangement and/or in the second arrangement based on the desired orientation of the second housing 130.

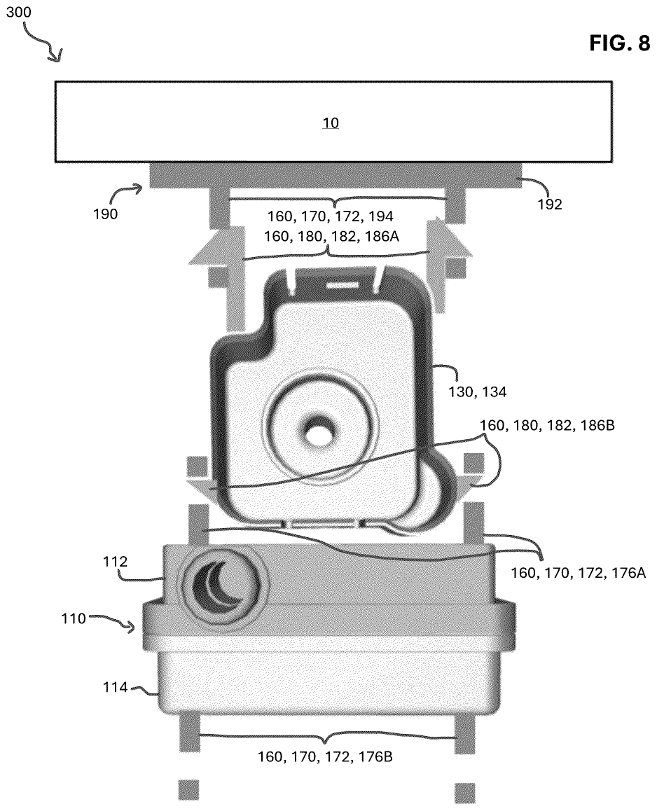

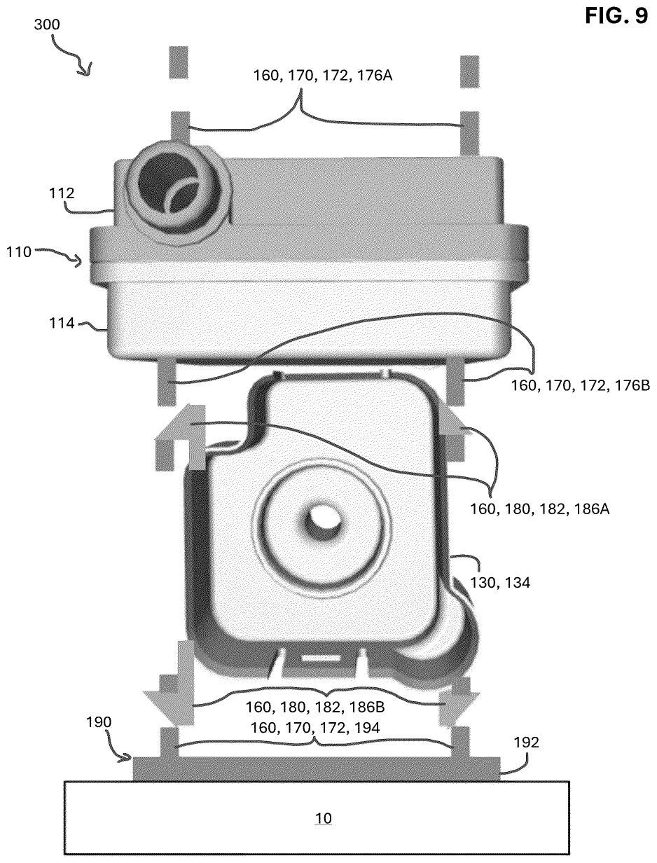

In other arrangements of the assembly 300 (e.g., FIGS. 8 and 9), one set of second fasteners 186A, 186B of the second housing 130 are engaged with one of the sets of first fasteners 176A, 176B of the first housing 110 and the other set of second fasteners 186A, 186B of the second housing 130 are engaged with the set of first fasteners 194 of the mounting bracket 190 such that the second housing 130 is disposed between and connects the first housing 110 and the mounting bracket 190 to one another. For example, in a third arrangement of the assembly 300 shown in FIG. 8, the first set of second fasteners 186A of the second housing 130 are engaged with the set of first fasteners 194 of the mounting bracket 190 and the second set of second fasteners 186B of the second housing 130 are engaged with the first set of first fasteners 176A of the first housing 110. In a fourth arrangement of the assembly 300 shown in FIG. 9, the first set of second fasteners 186A of the second housing 130 are engaged with the second set of first fasteners 176B of the first housing 110 and the second set of second fasteners 186B of the second housing 130 are engaged with the set of first fasteners 194 of the mounting bracket 190. The sets of second fasteners 186A, 186B of the second housing 130 may alternatively be connected to the other set of first fasteners 176A, 176B of the first housing 110 in the third arrangement and/or in the fourth arrangement based on the desired orientation of the first housing 110.

In further arrangements of the assembly 300, such as a fifth arrangement depicted in FIG. 10, the first housing 110 and the second housing 130 are not directly connected to one another (e.g., via the attachment formations 160) and are each individually connected to the support structure 10 of the vehicle via a respective mounting bracket 190 of a plurality of mounting brackets 190.

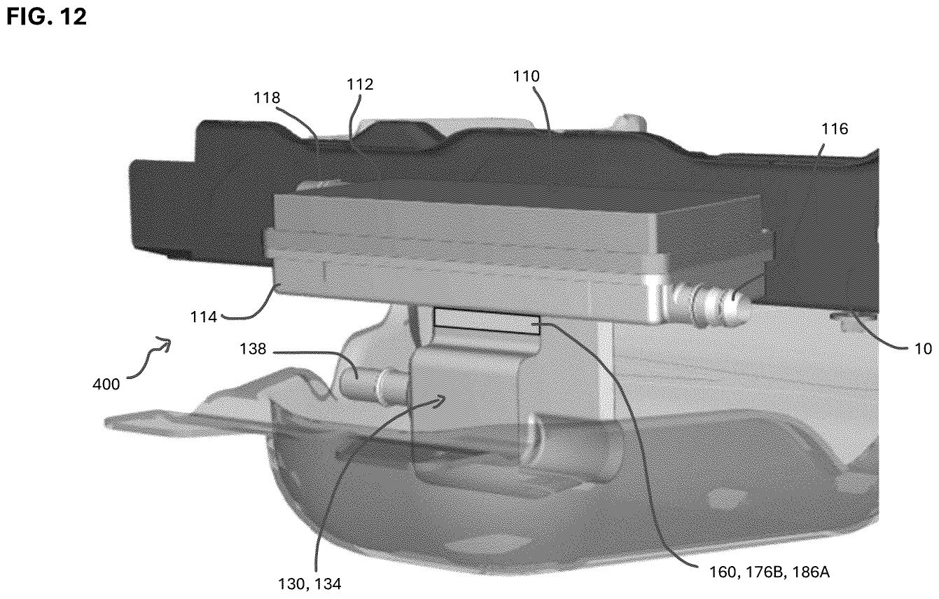

The illustrative assembly 400 depicted in FIG. 12 is a variation of the assembly 300 depicted in FIGS. 5-11 in which the two sets of first fasteners 176A, 176B are disposed on adjacent and/or transversely extending sides of the first housing 110. The second set of first fasteners 176B are arranged on a first and/or bottom side of the first housing 110 and are connected to the first set of second fasteners 186A of the second housing 130. While not visible in FIG. 12, the first set of first fasteners 176A of the first housing 110 arranged on a second and/or lateral side of the first housing 110 and are engaged with the set of second fasteners 196 of the mounting bracket 190, which is secured and/or connected to a lateral side and/or surface of the support structure 10. The first housing 110 is, therefore, laterally offset from the support structure 10 and the second housing 130 is suspended from and/or below the first housing 110.

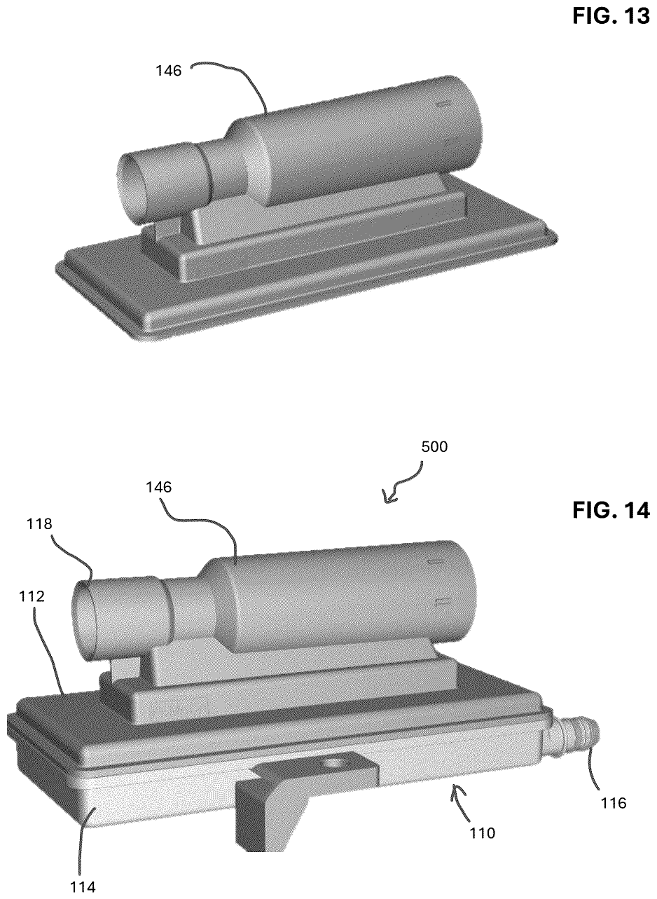

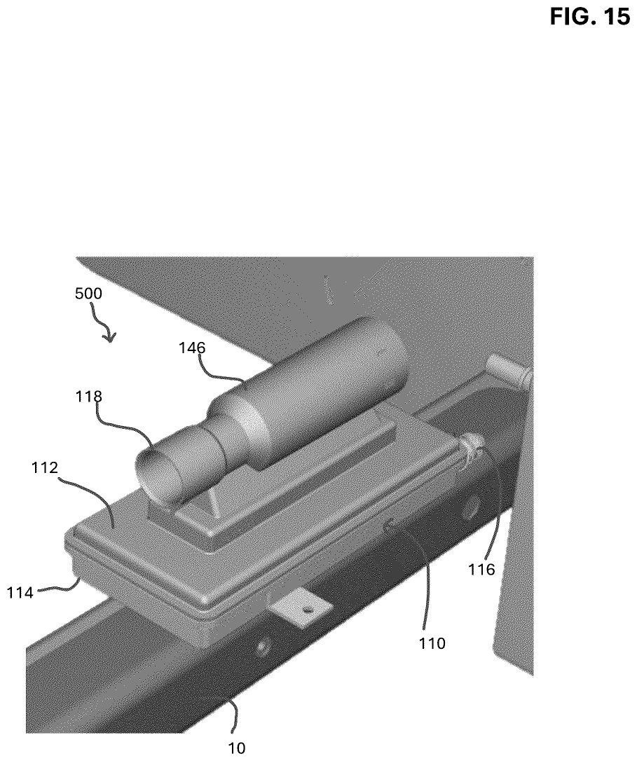

In some implementations, such as the exemplary assembly 500 depicted in FIGS. 14 and 15, the assembly 500 does not include the second housing 130. Rather, the first housing 110 and/or a portion thereof (e.g., the first housing shell 112) is configured as, connected to, and/or formed as a part of a bleed housing 146. The bleed housing 146, which is depicted in FIG. 13, is a plastic housing containing a hydrocarbon absorbent, such as a honeycomb monolith.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A modular dust box and electronic leak check module (ELCM) housing assembly, comprising:
a first housing;
a second housing;
a mounting bracket configured to secure the assembly to a support structure; and
a plurality of attachment formations including a plurality of first fasteners and a plurality of second fasteners configured in a complimentary manner to the plurality of first fasteners;
wherein at least one set of first fasteners is disposed on the first housing, at least one set of second fasteners is disposed on the second housing, and a set of first fasteners and/or a set of second fasteners is disposed on the mounting bracket such that the first housing, the second housing, and the mounting bracket are connectable to one another in a plurality of different arrangements via engaging at least some of the plurality of first fasteners and at least some of the plurality of second fasteners with one another.

2. The assembly according to claim 1, wherein:
the mounting bracket includes a base plate configured to be connected to the support structure; and
the set of first fasteners and/or the set of second fasteners are disposed on and project from the base plate.

3. The assembly according to claim 2, wherein the set of first fasteners and the set of second fasteners are arranged offset from one another on the base plate.

4. The assembly according to claim 1, wherein:
the at least one set of first fasteners of the first housing includes a plurality of sets of first fasteners; and
the at least one set of second fasteners of the second housing includes a plurality of sets of second fasteners.

5. The assembly according to claim 4, wherein:
the mounting bracket includes the set of first fasteners and the set of second fasteners;
in a first arrangement, i) a first set of first fasteners of the first housing are engaged with one of the plurality of sets of second fasteners of the second housing and ii) a second set of first fasteners of the first housing are engaged with the set of second fasteners of the mounting bracket; and
in a second arrangement, i) a first set of second fasteners of the second housing are engaged with one of the plurality of sets of first fasteners of the first housing and ii) a second set of second fasteners of the second housing are engaged with the set of first fasteners of the mounting bracket.

6. The assembly according to claim 1, wherein:
the at least one set of first fasteners of the first housing includes a plurality of sets of first fasteners;
a first set of first fasteners of the plurality of first fasteners are disposed on and project from a first side of the first housing; and
a second set of first fasteners of the plurality of first fasteners are disposed on and project from a second side of the first housing.

7. The assembly according to claim 6, wherein the second side of the first housing is:
disposed opposite the first side of the first housing; or
disposed adjacent to the first side of the first housing and oriented transversely to the first side.

8. The assembly according to claim 6, wherein:
the second side of the first housing is disposed opposite the first side of the first housing; and
a third set of first fasteners of the plurality of first fasteners are disposed on and project from a third side of the first housing, the third side disposed adjacent to the first side and oriented transversely to the first side.

9. The assembly according to claim 1, wherein:
each of the plurality of first fasteners are structured as a male fastener or a female fastener; and
each of the plurality of second fasteners are structured as the other of the male fastener and the female fastener.

10. The assembly according to claim 1, wherein:
the first housing is one of a filter housing and an ELCM housing; and
the second housing is the other one of the filter housing and the ELCM housing.

11. The assembly according to claim 10, further comprising:
a filter arranged in the filter housing; and
an ELCM arranged in the ELCM housing.

12. A modular dust box and electronic leak check module (ELCM) housing assembly, comprising:
a housing; and
a plurality of attachment formations connected to the housing;
wherein the housing is one of a filter housing and an ELCM housing; and
the housing is connectable to at least one of a support structure, a mounting bracket, and another housing via the plurality of attachment formations.

13. The assembly according to claim 12, wherein the plurality of attachment formations include a plurality of weld flanges.

14. The assembly according to claim 13, wherein each of the plurality of weld flanges includes a first member projecting from the housing and a second member disposed at a free end of the first member.

15. The assembly according to claim 12, further comprising the another housing, wherein the another housing is the other one of the filter housing and the ELCM housing.

16. The assembly according to claim 15, wherein:
the plurality of attachment formations include a plurality of first fasteners and a plurality of second fasteners configured in a complimentary manner to the plurality of first fasteners;
at least one set of first fasteners is disposed on and projects from the housing; and
at least one set of second fasteners is disposed on and projects from the another housing.

17. The assembly according to claim 16, wherein:
the at least one set of first fasteners of the housing includes a plurality of sets of first fasteners; and
the at least one set of second fasteners of the another housing includes a plurality of sets of second fasteners.

18. The assembly according to claim 17, wherein:
a first set of first fasteners of the plurality of first fasteners are disposed on and project from a first side of the housing; and
a second set of first fasteners of the plurality of first fasteners are disposed on and project from a second side of the housing.

19. The assembly according to claim 18, wherein the second side of the housing is:
disposed opposite the first side of the housing; or
disposed adjacent to the first side of the housing and oriented transversely to the first side.

20. The assembly according to claim 16, wherein:
each of the plurality of first fasteners are structured as a male fastener or a female fastener; and
each of the plurality of second fasteners are structured as the other of the male fastener and the female fastener.
